(19) United States
(12) Patent Application Publication
(10) Pub. No.: US 2008/0097657 A1
(43) Pub. Date: Apr. 24, 2008

(54) Method and System for Wafer Temperature Control

(75) Inventors: Kenneth E. Tinsley, Frisco, TX (US); Stuart A. Tison, McKinney, TX (US)

Correspondence Address: LOWRIE, LANDO & ANASTASI, LLP, ONE MAIN STREET, SUITE 1100, CAMBRIDGE, MA, 02142, US

(73) Assignee: Celerity, Inc., Austin, TX (US)

(21) Appl. No.: 11/664,550

(22) PCT Filed: Oct. 13, 2005
(86) PCT No.: PCT/US05/37130

§ 371 Date: Apr. 3, 2007

Related U.S. Application Data
(60) Provisional application No. 60/619,414, filed on Oct. 14, 2004.

(51) Int. Cl. G05D 23/00

(52) U.S. Cl. 700/300

(57) ABSTRACT

Systems and methods for controlling the temperature of a wafer are disclosed. These systems and methods may employ a back side wafer pressure control system (BSWPC) that includes subsystems and a controller operable in tandem to control the temperature of wafers in one or more process chambers. The subsystems may include mechanical components for controlling a flow of gas to the backside of a wafer while the controller may be utilized to control these mechanical components in order to control wafer temperature in a process chamber. Furthermore, embodiments of these systems and methods may also use a chiller in combination with the controller to provide both coarse and fine temperature control.

### RELATED APPLICATIONS AND PATENTS

This application claims priority under 35 U.S.C. § 119 to U.S. Provisional Patent Application No. 60/619,414, by Kenneth E. Tinsley and Stuart A. Tison, filed Oct. 14, 2004 entitled “Method and System for Integrated Pressure and Temperature Control,” which is hereby fully incorporated by reference.

### TECHNICAL FIELD OF THE INVENTION

The invention relates in general to methods and systems for controlling the temperature of a wafer in a processing environment, and more particularly, to systemized methods and systems for fine or coarse granularity temperature control.

### BACKGROUND OF THE INVENTION

Modern manufacturing processes sometimes entail precise stoichiometric ratios during particular manufacturing phases. This is particularly true during semiconductor fabrication utilizing a process chamber. Because of the need for these precise stoichiometric ratios, the temperature of the object being manufactured (sometimes referred to as a wafer) is critical, as the active chemistries with regards to the process chamber and the wafer are affected by the temperature of both the process chamber and the wafer itself.

More specifically, the temperature of the wafer may be particularly important during deposition or etch applications. Consequently, it is highly desirable to control the temperature of the wafer during manufacturing processes such as these. Temperature control, as it pertains to these wafers, may be important with respect to the average temperature of the wafer, however, it may also be important to control the temperature of a wafer with respect to particular locations of the wafer. For example, it may be desirable to establish a temperature gradient across a wafer surface during a particular process.

Currently, controlling the temperature of a wafer is accomplished, in the main, through the use of two techniques. The first of these involves a heat exchanger (known as a chiller). These chillers may use a variety of means to cool a wafer chuck, thus controlling the temperature of the wafer on the chuck. These types of techniques may be somewhat problematic, however, as the use of chillers may only be adequate to accomplish gross control over the temperature of a wafer in a process chamber.

Another method for temperature control of a wafer is the introduction of a pressure controlled (usually inert) gas between the wafer and the wafer chuck. A port may be present on the wafer chuck through which gas can be outlet onto the backside of the wafer. By controlling the pressure of the gas outlet onto the backside of the wafer the temperature of the wafer may be controlled. This technique is problematic as well. Controlling the pressure of gas outlet to the backside of the wafer may only allow a very fine temperature control. Thus, in some manufacturing processes the temperature of a wafer may exceed the cooling capabilities of a temperature control system utilizing a backside cooling gas. Furthermore, in some cases the wafer may be so large that in order to maintain a desired wafer temperature multiple zones of a wafer may need to be established and the pressure of gas in each of these zones controlled, greatly increasingly the complexity of these temperature control systems.

Temperature control systems for wafers may be quite expensive to implement as well, as in most cases these temperature control systems are implemented on a per-process-chamber basis. In other words, for each process chamber where it is desired to implement wafer temperature control it may be necessary to incorporate physical hardware required for wafer temperature control.

Some limitations of the above described temperature control methodologies stem from the lack of data available to these systems. As there is typically no way to determine the actual temperature of the wafer itself these systems employ control algorithms which typically do not take into account the wafer temperature itself or other process variables which may affect the temperature of the wafer. Additionally, because of the limited number of process variables utilized, these control algorithms may suffer from crosstalk issues.

Thus, as can be seen, there is a need for reduced cost systems and methods for controlling the temperature of a wafer which can take into account the temperature of the wafer or other process variables.

### SUMMARY OF THE INVENTION

Systems and methods for controlling the temperature of a wafer are disclosed. These systems and methods may employ a back side wafer pressure control system (BSWPC) that includes subsystems and a controller operable in tandem to control the temperature of wafers in one or more process chambers. The subsystems may include mechanical components for controlling a flow of gas to the backside of a wafer while the controller may be utilized to control these mechanical components in order to control wafer temperature in a process chamber. Furthermore, embodiments of these systems and methods may also use a chiller in combination with the controller to provide both coarse and fine temperature control.

In one embodiment, a set of process variables associated with a process chamber, including the temperature of a wafer may be sensed and an error calculated utilizing a setpoint and the set of process variables. Based on this error the pressure of a gas outlet onto a wafer may be based on adjusted to reduce the error.

In other embodiments, a chiller may also be controlled based on the error.

Certain embodiments of the invention may utilize temperature sensors for sensing data related to a temperature of a wafer, subsystem operable to regulate a pressure of a gas outlet onto the wafer and a control system operable to calculate an error utilizing a setpoint and a set of process variables and control the subsystem based on the calculated error.

In some embodiments, the control system may employ a first order heat transfer equation.

Embodiments of the present invention may provide the technical advantage of allowing the temperature of a wafer, or a surrogate thereof, and other process variables, to be taken into account when controlling the temperature of the wafer. By utilizing a chiller and subsystems intended to regulate the pressure of gas to the backside of wafer together certain embodiments of the present invention may also provide the technical advantage of allowing both coarse and fine grained temperature control to be utilized in combination. By allowing both coarse and fine grained temperature control not only may error between a temperature setpoint and an actual temperature be reduced more effectively, but additionally, a ramp for any temperature changes that are needed may more easily be optimized.

Furthermore, some of the embodiments of the present invention may be systemized by combining the subsystems intending to regulate the flow of gas to a process chamber and the controller for controlling these subsystems. This may allow systemized wafer temperature control systems such as these to be separated from a tool controller allowing the cost and complexity of the wafer temperature control system, and hence of the process tool itself, to be reduced.

Similarly, embodiments of the present invention may allow the subsystems intending to regulate the flow of gas to be distributed among process chambers while the control systems intended to control these subsystems may be centralized and separated from the tool controller. This allows embodiments of this type to exhibit increased response times while still allowing costs and complexity to be reduced.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 includes a block diagram of one embodiment of an integrated back side wafer pressure control system.

FIG. 2 includes a block diagram of one embodiment of a back side wafer pressure control system with distributed mechanical subsystems.

FIG. 3 includes a block diagram of one embodiment of an integrated back side wafer pressure control system including a chiller.

FIGS. 4A and 4B include schematic diagrams of embodiments of integrated pressure control devices which may be utilized with embodiments of the present invention.

FIG. 5 include a diagram of a prior art pressure control system.

FIG. 6 includes a diagram of one embodiment of a wafer temperature control system.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. After reading the specification, various substitutions, modifications, additions and rearrangements which do not depart from the scope of the appended claims will become apparent to those skilled in the art from this disclosure.

Attention is now directed to systems and methods for controlling the temperature of a wafer. These systems and methods may employ a back side wafer pressure control system (BSWPC) that includes mechanical subsystems and a controller operable in tandem to control the temperature of wafers in one or more process chambers. The mechanical subsystems may include mechanical components for controlling a flow of gas to the backside of a wafer while the controller may be utilized to control these mechanical components in order to control wafer temperature in a process chamber. Furthermore, embodiments of these systems and methods may also use a chiller in combination with the controller to provide both coarse and fine temperature control.

The controller of a BSWPC may employ a closed-loop control algorithm for controlling the temperature of wafers in one or more process chambers. The control algorithm may utilize multiple process variables, including a wafer temperature, or a surrogate thereof, to control the pressure of gas on the backside of the wafer and/or the chiller which, in turn, controls (directly or indirectly) the temperature of a wafer.

One of ordinary skill in the art will understand there are multiple ways to implement back side wafer pressure control and multiple ways to implement a chiller/chuck temperature control system and, in one embodiment, the invention provides a controller that controls one or both of these types of systems to control, monitor, adjust or correct wafer temperature in a closed loop system using any number of process variable inputs. More specifically, if the wafer temperature falls out of a certain alarm range of a setpoint the present invention can use feedback information to correct and adjust the wafer temperature. By systemizing the BSWPC, the complexity of a process tool may be reduced improving the wafer fabrication processes while simultaneously reducing the cost of these processes or the systems that implement these processes.

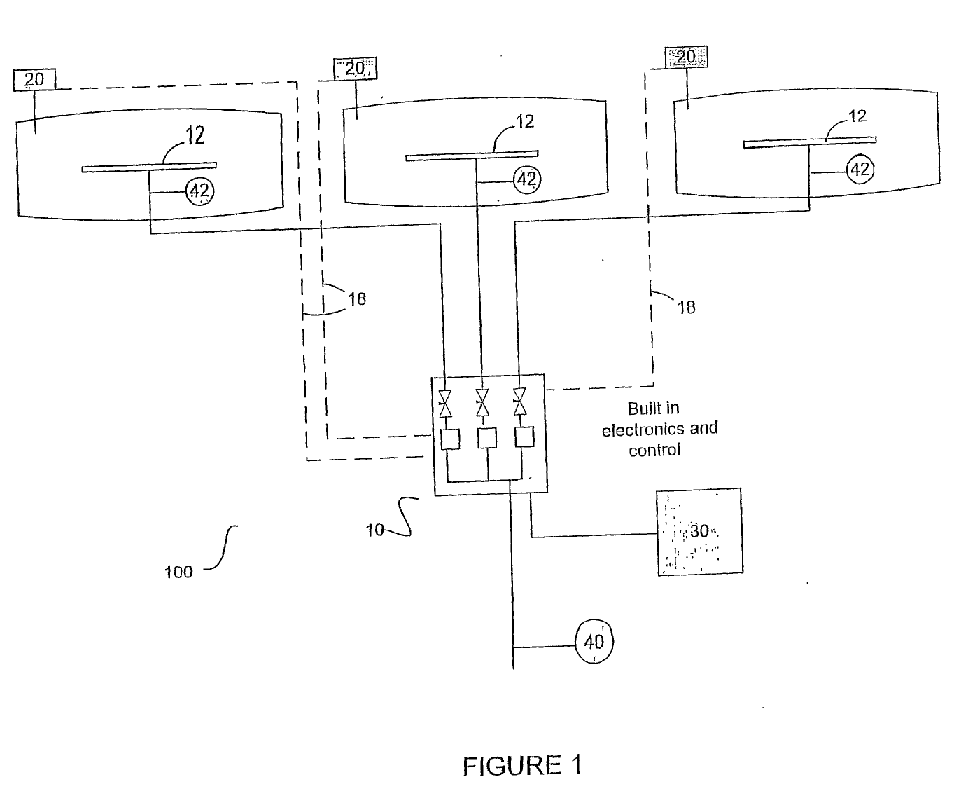

Turning to FIG. 1, a block diagram of a process tool 100 including one embodiment of a back side wafer pressure control (BSWPC) system of the present invention is depicted. Process tool 100 may have process chambers 14, each of the process chambers 14 including wafer chuck 12. BSWPC system 10 may be operable to control the pressure of gas delivered to the backside of a wafer placed on wafer chuck 12 (or a chiller, not pictured in this embodiment), and hence the temperature of the wafer.

BSWPC system 10 may include a controller for controlling the pressure of gas delivered to any one of process chambers 14 and the subsystems including components (mechanical and otherwise, e.g. valves/sensors, but which may be referred to collectively as mechanical subsystems) to provide appropriate flow to achieve the desired pressure to the backside of the wafers on wafer chucks 12. As shown, each wafer chuck 12 (for each wafer (not shown)) is connected to the BSWPC system 10 via lines 16. Thus, by regulating or controlling the flow of gas through a particular line 16, the BSWPC system 10 may control the pressure of gas to the backside of the wafer on a particular chuck 12.

In one embodiment, process tool 100 can include a temperature sensor 20 for each process chamber 14 to provide wafer temperature, or a surrogate thereof, as a signal input to the BSWPC system 10 via lines 18. Temperature sensors 20 can be optical temperature sensors or any other temperature sensor capable of providing localized wafer temperature information, or data related to localized wafer temperature, to the BSWPC system 10 in a process environment, including temperature sensors which provide the temperature of a wafer or information related to the temperature of the wafer, such as the temperature of the chuck, temperature of a gas, or plasma power which may be used as a surrogate for gas temperature, etc. Process tool 100 may also include pressure sensors 42 to provide a point of use (POU) pressure which may be used in compensating for pressure transients. As BSWPC system 10 may regulate the backside wafer pressure to each process chamber 14 utilizing gas supplied by a single gas line, BSWPC system 10 can also utilize data from a single upstream pressure sensor 40 to compensate for upstream pressure transients and reduce the associated costs.

During operation, BSWPC system 10 may receive setpoints (e.g. pressure or temperature) associated with one or more process chambers 14, or wafers on wafer chucks 12, from tool controller 30. Based on this setpoint, BSWPC system 100 may control the pressure of gas at the backside of one or more wafers on wafer chuck 12 by controlling a pressure control device associated with that process chamber 14 utilizing process variables including those provided by temperature sensors 20, pressure sensors 40, 42 or tool controller 30. The BSWPC system 10 can therefore actually control and correct for errors in wafer temperature based on the inputs received at the BSWPC system 10 (as described more fully below). It is important to note that data provided by temperature sensors 20 or pressure sensors 40, 42 may be provided directly to BSWPC system 10, reducing the computational complexity required by tool controller 30.

As, in this embodiment, BSWPC system 10 includes both the controller and the subsystems, this embodiment allows for one interface to the tool controller 30 (from the BSWPC system 10) and the use of single upstream pressure sensor 40, reducing the space requirements for BSWPC system 10, the complexity of process tool 100 and, commensurately, the cost of process tool 100.

While the embodiment of the present invention described with respect to FIG. 1 may be useful in cases where an significant consideration is to reduce the cost of process tool, in other instances it may be desirable to achieve quicker response times and temperature control. To accomplish these goals, in certain embodiments of the present invention the mechanical sub-systems of a BSWPC system may be distributed.

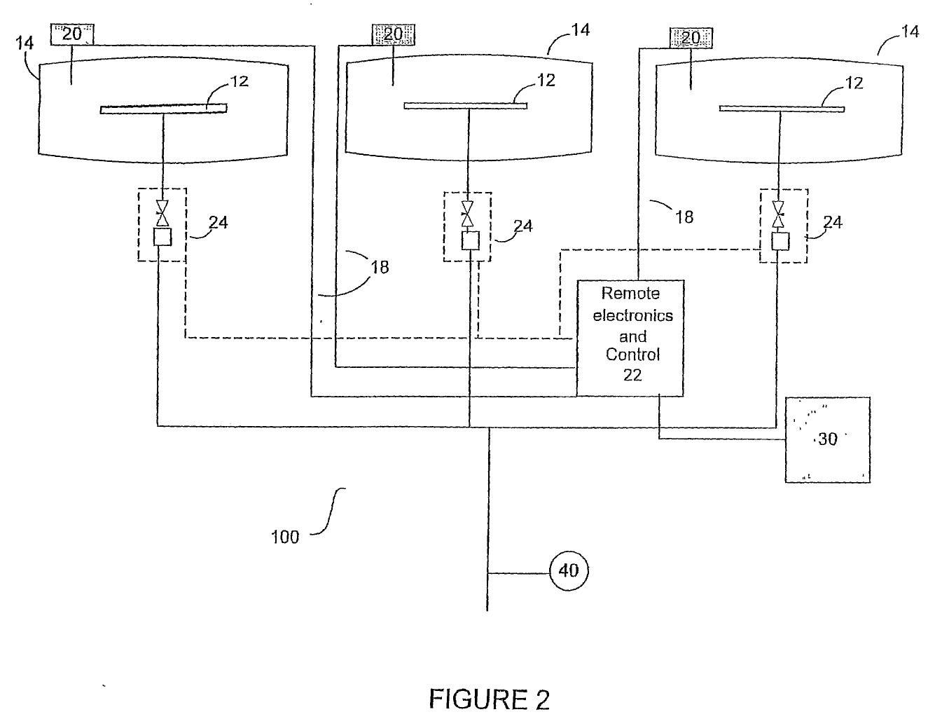

FIG. 2 depicts a block diagram of an alternative embodiment of the present invention. Process tool 100 may have process chambers 14, each of the process chambers 14 including a wafer chuck 12. A BSWPC system may be operable to control the pressure of gas delivered to the backside of a wafer placed on wafer chuck 12, and hence the temperature of the wafer.

The BSWPC system may include a single controller 22 to control BSWPC subsystems 24, where controller 22 provides the control functions for each of separate and remote BSWPC subsystems 24, each of which is coupled to a process chamber 14. The BSWPC subsystems 24 provide the devices (mechanical and otherwise) to perform flow adjustments as instructed by the controller 22 to control the backside pressure at the wafer on wafer chuck 12 in their respective process chamber 14.

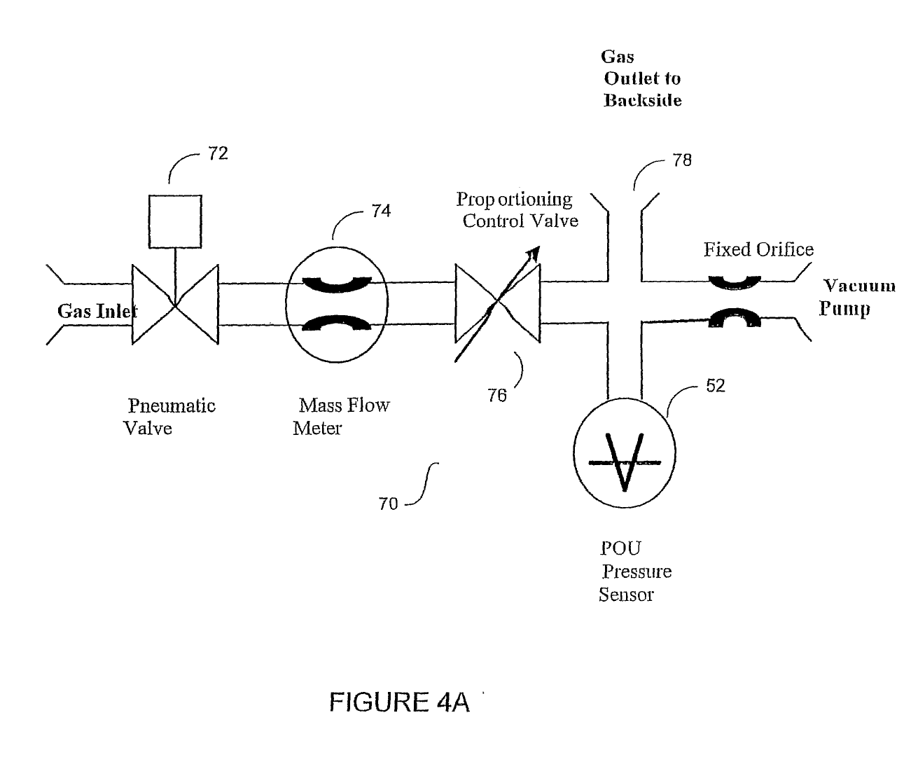

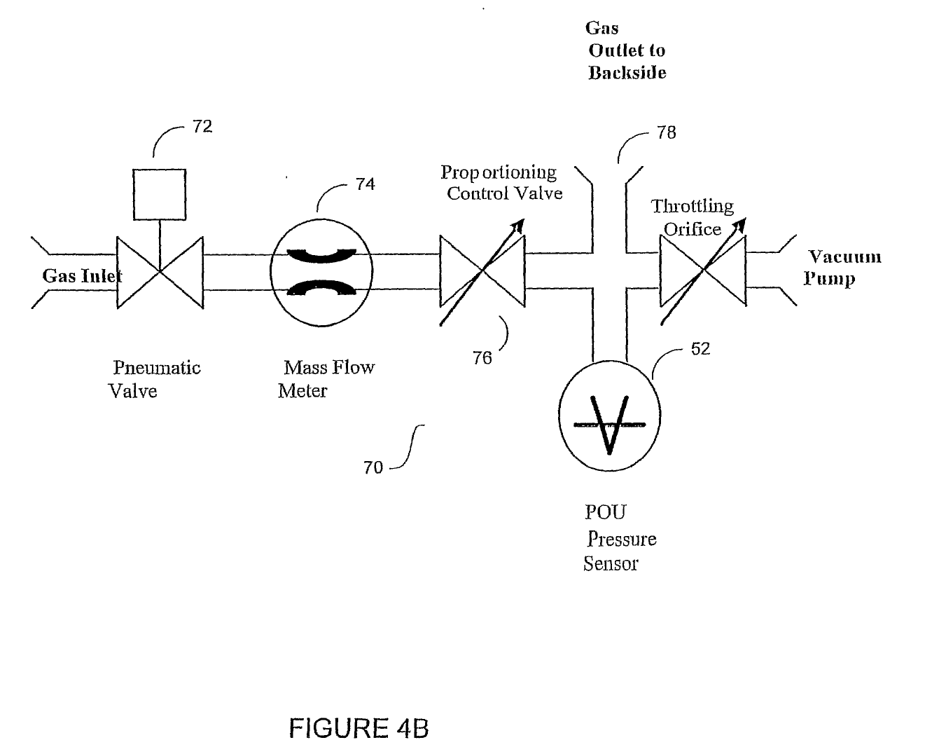

In one embodiment, BSWPC subsystem 24 includes a pressure transducer, valve and flow meter/sensor. In another embodiment, the BSWPC subsystem 24 could include one of the integrated pressure control devices shown in FIG. 4A or 4B (and described in more detail below).

During operation, BSWPC controller 22 may receive setpoints (e.g. pressure or temperature) associated with one or more process chambers 14, or wafers on wafer chucks 12, from tool controller 30. Based on these setpoints, BSWPC controller 22 may control one or more BSWPC subsystems 24 in order to regulate the pressure of gas at the backside of one or more wafers on wafer chuck 12 utilizing process variables, including data provided by temperature sensors 20, pressure sensors 40, 42 or tool controller 30. The BSWPC controller 22, via control of subsystems 24, can therefore actually control and correct for errors in wafer temperature based on received inputs (as described more fully below). As controller 22 is separate from subsystems 24, this embodiment also allows for a single interface to the tool controller 30.

As can be seen, the embodiment of the present invention depicted in FIG. 2 allows for a small BSWPC subsystem 24 to be directly installed next to or near the wafer chuck 12, while being controlled by remote electronics and control residing at controller 22. When compared to the embodiment of the present invention depicted in FIG. 1 it can be seen that the embodiment of FIG. 2 reduces the gas volume between the BSWPC subsystem 24 and the wafer chuck 12 and thus enables improved pressure control via faster response times.

Though the embodiments of the present invention depicted with respect to FIGS. 1 and 2 are effective at regulating the temperature of a wafer on a wafer chuck, the use of temperature control through the regulation of the pressure of a gas introduced to the backside of the wafer may be most useful for regulating the temperature of a wafer within a relatively small window, and may provide a fine degree of control. Many manufacturing processes, however, may require relatively large swings in temperature between different stages. Thus, it is also desirable to have a way to obtain a coarser granularity in the ability to control the temperature of a wafer.

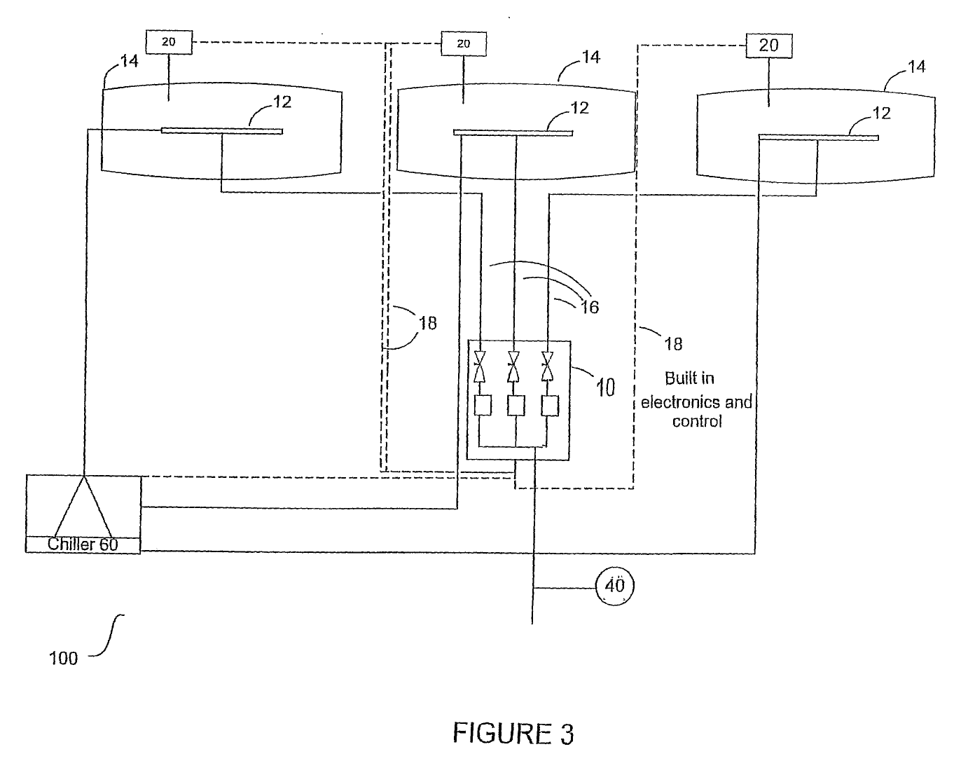

FIG. 3 depicts one embodiment of the present invention with just such control. Process tool 100 includes the BSWPC system 10 of FIG. 1, but that now includes a chiller 60 coupled to both wafer chucks 12 and the BSWPC system 10. BSWPC system 10 of FIG. 3 utilizes the BSWPC controller to control backside wafer pressure (and therefore wafer temperature) as described with respect to FIG. 1. Additionally, in this embodiment, the BSWPC controller controls chiller 60 to regulate the temperature of wafer chuck 12 (and therefore wafer temperature). BSWPC controller may regulate chiller 60 by sending a setpoint to chiller 60 or BSWPC controller may control the components of the chiller 60 (e.g., it can control the compressor and the individual heat exchangers of chiller 60 required to control the individual chamber temperatures).

During operation, BSWPC system 10 may receive pressure or temperature setpoints associated with one or more process chambers 14, or wafers on wafer chucks 12, from tool controller 30. Based on these setpoints, BSWPC system 10 may control the pressure of gas at the backside of one or more wafers on wafer chuck 12 and chiller 60 utilizing process variables including those provided by temperature sensors 20, pressure sensors 40, 42 or tool controller 30. In this manner, the BSWPC controller will have improved temperature control, both coarse and fine adjustment capabilities, and the ability to optimize the ramp for any changes in temperature that could be required for a particular process.

It will be apparent to those of skill in the art that though the embodiment of the present invention depicted in FIG. 3 utilizes the single integrated BSWPC of FIG. 1 the remote, distributed BSWPC controller and individual BSWPC subsystems of FIG. 2 can be substituted for the single integrated controller/subsystem shown in FIG. 3 with similar efficacy.

Moving now to FIG. 4A, a functional diagram of one embodiment of a pressure control device 70 that can be used within BSWPC subsystem 24 or with subsystems of BSWPC system 10 is depicted. FIG. 4A shows the gas inlet from gas line 26 going into pneumatic control valve 72 which may be an on/off valve to allow gas to flow through control device 70. Out of pneumatic valve 72, the gas flows through mass flow meter 74 (e.g., thermal sensor) and proportioning control valve 76 prior to going to a wafer chuck 12 via port 78 (in other embodiments proportioning control valve 76 may be placed upstream of mass flow meter 74). Control device 70 can include a POU or point of use pressure sensor 52 which may be operable to sense the pressure of gas flowing through port 78 to wafer chuck 12, and a connection though a fixed orifice to a vacuum pump. The fixed orifice may be used to bleed gas such that the pressure of gas flowing through port 78 may be adjusted.

In some cases, however, the use of a fixed orifice in control device 70 may be a limiting factor with respect to the transition time of control device 70 or the dynamic range of control device 70, as the fixed orifice may only be optimized for a limited set of parameters. To alleviate some, if not all, of the limitations of utilizing a fixed orifice, a throttling orifice may be utilized in conjunction with control device 70 instead of a fixed orifice. FIG. 4B depicts a functional diagram of one embodiment of a pressure control device 70 utilizing a throttling orifice that can be used within BSWPC subsystem 24 or with subsystems of BSWPC system 10. By using a throttling orifice instead of a fixed orifice to bleed gas such that the pressure of gas flowing through port 78 may be adjusted, control device 70 may be operable and effective within a wider dynamic range.

Though the integrated pressure control devices 70 depicted in FIGS. 4A and 4B may be particularly effective when utilized to control pressure at the backside of the wafer, other similar devices can also be used in conjunction with embodiments of the present invention to control the backside wafer pressure. Additionally, while the ability to control backside wafer pressure is known and can be performed in embodiments of the present invention using known and to be developed methodologies, including those provided in the prior art, other embodiments of the systems and methods of the present invention may employ new and novel methodologies.

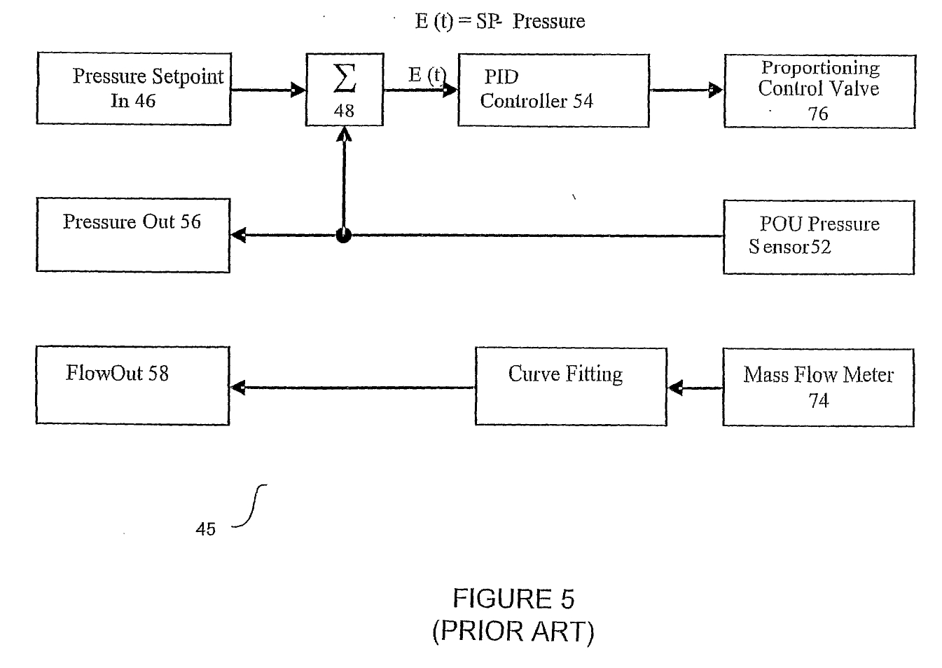

It may be helpful here to illustrate one of these prior art methodologies for controlling backside wafer pressure in conjunction with the novel embodiments of the systems of the present invention depicted in FIGS. 1-3 and the pressure control device of FIG. 4A. FIG. 5 depicts just such a prior art pressure control subsystem 45 for the control of the pressure of gas to the backside of a wafer. Pressure setpoint input 46 is provided by tool controller 30 to comparator or summer 48. The comparator 48 also receives a POU pressure signal from POU pressure sensor 52 or POU pressure sensor 42. The result from comparator 48 (comparing the pressure setpoint with the sensed pressure) can be sent to Proportional Integrated Derivative (PID) controller 54 to control proportioning control valve 76. POU pressure sensors 52 can also send the pressure signal as a pressure output 56 to other parts of the system, including tool controller 30. Also, as shown in FIG. 5, mass flow meter 74 can provide a flow output signal 58 to another part of the system (e.g., to tool controller 30) and can utilize known curve fitting functions in this process.

While the pressure control methodology depicted with respect to FIG. 5 is somewhat effective for controlling the pressure of a gas, when controlling the pressure of a gas in order to effect the temperature of a wafer it may be particularly useful to utilize a wide variety of process variables in conjunction with the control algorithm, including the temperature of the wafer itself.

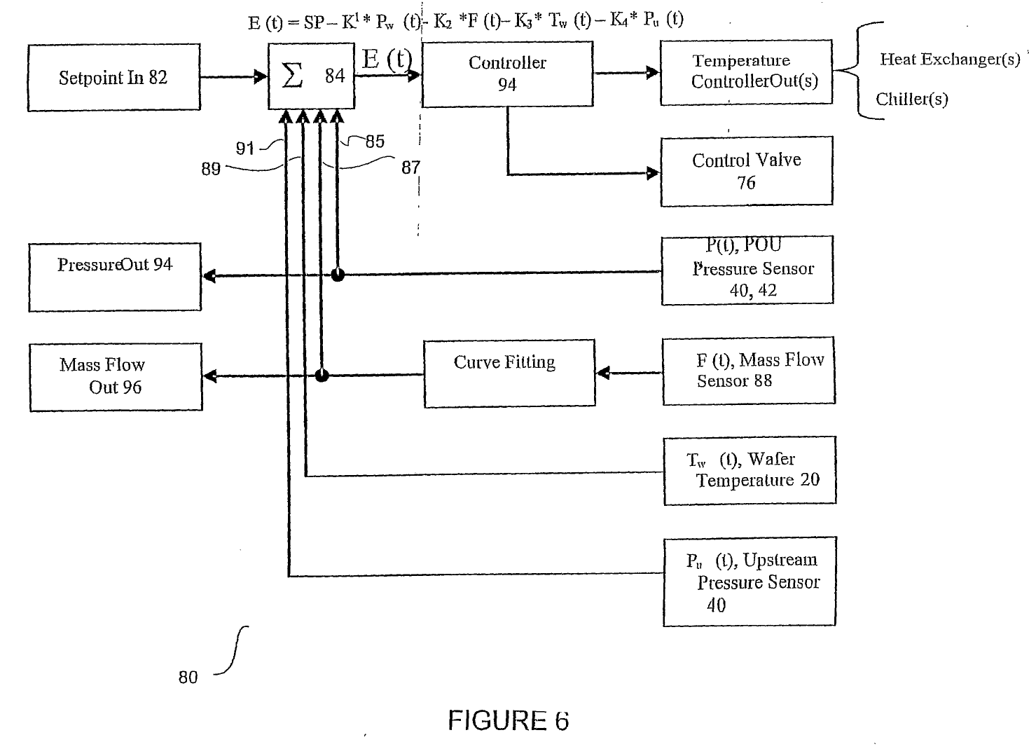

FIG. 6 depicts one embodiment of a closed loop control system 80 used to control wafer temperature during chamber operations (e.g. deposition, etch, etc.) according to the present invention. Closed loop control system will be described in conjunction with the systems of the present invention depicted in FIGS. 1-4, particularly with respect to regulating the temperature of a wafer in one of process chambers 12.

Tool controller 30 (or an overall system controller) may provide setpoint input 82. This setpoint input 82 from tool controller 30 can be a pressure setpoint, a temperature setpoint or a flow setpoint. The particular type of setpoint may be indicated by an index value. For example, the index for each setpoint input could be as follows:

| Setpoint Types | Index |
|---|---|
| Pressure | 0 |
| Flow | 1 |
| Wafer Temperature | 2 |

In one embodiment, the invention could include a selector (e.g., processor and software or other interpretation scheme; which can be part of comparator/summer/error calculation device 84 or separate from comparator 84), that could receive information that would identity what type of setpoint information was coming from tool controller 30. As an example, the format of such information to the selector could be SP<x,y> where x represents the index number (e.g., 0 indicating pressure is the variable, 1 indicating flow, 2 indicating wafer temperature) and y indicating the setpoint desired in the appropriate variable (e.g., SP<1,200> could indicate the setpoint variable is flow and the setpoint desired is 200 sccm). For purposes of the following description setpoint input 82 will be described as a temperature setpoint.

After receiving a setpoint, closed loop control system 80 may then utilize a variety of measured or calculated process variables to accomplish temperature control of a wafer in process chamber 14 by regulating one or both of back side wafer pressure (e.g., via flow control) or chuck temperature (e.g., via chiller control).

In one embodiment, comparator 84 takes the input setpoint 82 from tool controller 30 and process variables (e.g., sensed signals or modified sensed signals) of pressure, flow and temperature as follows: the sensed POU pressure (back side wafer pressure) 85, mass flow signal 87, wafer temperature 89 and upstream pressure 91.

POU pressure 85 (back side wafer pressure) may be received from POU pressure sensor 52 or POU pressure sensor 42; mass flow signal 87 may be a mass flow sensed by a mass flow sensor 88 and corrected by one or more correction factors or a curve fitting algorithm; wafer temperature 89 may be sensed by temperature sensor 20 and upstream pressure 91 may be sensed by upstream pressure sensor 40. Each of these process variables may be sent directly from the corresponding sensor or from tool controller 30

From these process variables, comparator 84 may calculate an error with respect to setpoint input 82. The error calculation can be done, in one embodiment, by utilizing a first order heat transfer equation of the following form: E(t)=Setpoint−K₁*POU_Pressure−K₂*Mass_Flow−K₃*Wafer_Temp−K₄*UP_Pressure.

In some embodiments, the first order heat transfer equation may be of the following form: E(t)=setpoint ? K1*POU_Pressure ? K2*Mass_Flow ? K3*Wafer_Temp−K4*UP_Pressure, where the range of values for K1, K2, K3, and K4 may vary depending on the system volume, system mass, system schematic, materials, and desired response characteristics, but are typically in the range of substantially 0 to substantially 10,000.

Notice that each process variable utilized in the algorithm employed by comparator 84 in calculating the error employs a coefficient K. The values of these K terms in the error algorithm can be scaled to achieve the desired process control. Notice, as well, that by utilizing a K of 0 with a particular process variable that process variable may be removed from the error calculation.

Thus, utilizing a form of the above equation, comparator 84 can determine an error value utilizing inputs 82, 85, 87, 89 and 91 (or a subset thereof) to determine an error value. This error value can, in turn, be provided to controller 94. Controller 94 can then, based on this error value, provide the appropriate output to one or both of temperature controller 98 (which is operable to output control signals to chiller 60 or subcomponents of chiller 60 (e.g., heat exchanger) based on the input received from controller 94) and/or control valve 76 to control pressure and/or flow of pressure control device 70. In this manner, wafer temperature control system 80 can control wafer temperature with both fine (backside wafer pressure) and coarse (chiller) temperature control. As shown in FIG. 6, the integrated wafer temperature control system 80 can also provide the pressure 94 and mass flow 96 signals as outputs to the tool controller 30 (although not shown, wafer temperature and upstream pressure could also be provided to tool controller 30).

Note that while the closed loop control system of FIG. 6 has been described with respect to FIGS. 1-3 and 4A, the closed loop control system may be utilized in conjunction with other BSWPC systems and the BSWPC systems of FIGS. 1-3 may be utilized in conjunction with other pressure control devices than those depicted with respect to FIGS. 4A and 4B and with other control systems than that depicted with respect to FIG. 6.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method of controlling the temperature of a wafer in a process chamber, comprising:
sensing a plurality of process variables associated with a process chamber, the plurality of process variables including at least one process variable indicative of the temperature of a wafer;
calculating an error utilizing a setpoint and the plurality of process variables; and
controlling a pressure of a gas outlet onto a wafer based on the error.

2. The method of claim 1, further comprising controlling a chiller based on the error.

3. The method of claim 2, further comprising calculating a control signal for the chiller based on the error.

4. The method of claim 2, wherein controlling the pressure of a gas comprises controlling a pressure control device.

5. The method of claim 4, wherein the pressure control device comprises a fixed orifice.

6. The method of claim 5, wherein the pressure control device comprises a throttling orifice.

7. The method of claim 4, further comprising calculating a control signal for the pressure control device.

8. The method of claim 2, wherein the process variables comprise a point of use (POU) pressure, a mass flow and an upstream pressure.

9. The method of claim 8, wherein the mass flow has been corrected using a curve fitting algorithm.

10. The method of claim 2, wherein calculating an error comprises modifying each of the process variables with a coefficient.

11. The method of claim 10, wherein calculating an error is done using a first order heat transfer equation.

12. The method of claim 10, wherein calculating an error is done using an equation of the form: E(t)=setpoint−K₁*POU_Pressure−K₂*Mass_Flow−K₃*Wafer_Temp−K₄*Up_Pressure.

13. A system for controlling the temperature of a wafer in a process chamber, comprising:
a temperature sensor for sensing data related to a temperature of a wafer;
a subsystem operable to regulate a pressure of a gas outlet onto the wafer; and
a control system operable to calculate an error utilizing a setpoint and a plurality of process variables, including the data related to the temperature of the wafer, and to control the subsystem based on the error.

14. The system of claim 13, further comprising a chiller, wherein the control system is further operable to control the chiller based on the error.

15. The system of claim 14, wherein the control system and the subsystem are integrated.

16. The system of claim 14, wherein the control system and the subsystem are distributed.

17. The system of claim 14, wherein the control system is further operable to calculate a control signal for the chiller based on the error.

18. The system of claim 17, wherein the subsystem comprises a pressure control device.

19. The system of claim 18, wherein the pressure control device comprises a fixed orifice.

20. The system of claim 19, wherein the pressure control device comprises a throttling orifice.

21. The system of claim 18, wherein the controller is further operable to calculate a control signal for the pressure control device.

22. The system of claim 21, further comprising a point of use (POU) pressure sensor, a mass flow sensor and an upstream pressure sensor.

23. The system of claim 22, wherein the pressure control device comprises the POU pressure sensor.

24. The system of claim 18, wherein calculating an error comprises modifying each of the process variables with a coefficient.

25. The system of claim 24, wherein calculating an error is done using a first order heat transfer equation.

26. The system of claim 24, wherein calculating an error is done using an equation of the form: E(t)=setpoint−K₁*POU_Pressure−K₂*Mass_Flow−K₃*Wafer_Temp−K₄*Up_Pressure.

27. A system for controlling the temperature of a wafer in a process chamber comprising:
a plurality of temperature sensors, each temperature sensor operable for sensing data related to a temperature of a wafer in a respective process chamber of a plurality of process chambers;
a chiller; and
an integrated back side wafer pressure control system comprising:
a plurality of subsystems, each subsystem associated with a respective process chamber and comprising a pressure controller device operable to regulate a pressure of a gas outlet onto the wafer in the respective process chamber, and
a control system operable to calculate an error corresponding to one or more of the plurality of process chambers utilizing a setpoint and a plurality of process variables associated with the one or more process chambers, including the data related to the temperature of the wafer in the one or more process chambers, and further operable to control the subsystem associated with the one or more process chambers and the chiller based on the calculated error.

28. A method of controlling the temperature of a wafer in a process chamber, comprising:
sensing a plurality of process variables associated with a process chamber, including data related to the temperature of the wafer, a pressure of gas at the backside of the wafer and a flow of gas to the wafer chuck;
calculating an error utilizing a setpoint and the plurality of process variables; and
controlling a pressure of a gas outlet onto the wafer based on the error.

29. The method of claim 28, wherein the data related to the temperature of the wafer includes at least one of a temperature of a chuck, a temperature of the gas and a plasma power.

30. The system of claim 13, wherein the plurality of process variables further includes a flow rate of the gas.

31. The system of claim 30, wherein the plurality of process variables further includes a power supplied to a plasma.

32. The method of claim 28, further comprising controlling a chiller based on the error.

33. The method of claim 1, wherein the plurality of process variables further includes a flow rate of the gas.

34. The method of claim 33, wherein the plurality of process variables further includes a power supplied to a plasma.

35. The system of claim 13, wherein the plurality of process variables further includes a power supplied to a plasma.

36. The system of claim 14, wherein the plurality of process variables further includes a flow rate of the gas.

37. The system of claim 14, wherein the plurality of process variables further includes a power supplied to a plasma.

38. The system of claim 27, wherein the plurality of process variables further includes a flow rate of the gas.

39. The system of claim 27, wherein the plurality of process variables further includes a power supplied to a plasma.

40. The method of claim 1, wherein the plurality of process variables further includes a power supplied to a plasma.

41. The method of claim 2, wherein the plurality of process variables further includes a flow rate of the gas.

42. The method of claim 2, wherein the plurality of process variables further includes a power supplied to a plasma.

43. The method of claim 28, wherein the plurality of process variables further includes a power supplied to a plasma.

44. The method of claim 28, wherein the plurality of process variables further includes a flow rate of the gas.

45. The method of claim 32, wherein the plurality of process variables further includes a flow rate of the gas.

46. The method of claim 32, wherein the plurality of process variables further includes a power supplied to a plasma.

47. A method of controlling a temperature of a wafer in a process chamber, comprising:
sensing a plurality of process variables associated with the process chamber, the plurality of process variables including at least one process variable indicative of the temperature of the wafer;
calculating an error utilizing a setpoint and the plurality of process variables; and
controlling at least one of a pressure and a flow rate of a gas outlet onto the wafer based upon the error.

48. The method of claim 48, wherein controlling at least one of a pressure and a flow rate of a gas outlet onto the wafer based upon the error includes controlling both the pressure and the flow rate of the gas outlet onto the wafer based upon the error.

49. The method of claim 48, wherein the setpoint is one of a temperature setpoint, a pressure setpoint, and a flow rate setpoint.

50. A system for controlling a temperature of a wafer in a process chamber, comprising:
a temperature sensor for sensing data related to the temperature of the wafer;
a subsystem operable to regulate at least one of a pressure and a flow rate of a gas outlet onto the wafer; and
a control system operable to calculate an error utilizing a setpoint and a plurality of process variables, including the data related to the temperature of the wafer, and to control the subsystem based upon the error.

51. The system of claim 50, wherein the subsystem is operable to regulate both the pressure and the flow rate of the gas outlet onto the wafer.

52. The system of claim 50, wherein the setpoint is one of a temperature setpoint, a pressure setpoint, and a flow rate setpoint.
